(19) United States
(12) Patent Application Publication
(10) Pub. No.: US 2011/0320297 A1
(43) Pub. Date: Dec. 29, 2011

(54) PREPAID CARD PROCESSING DEVICE, PREPAID CARD PROCESSING SYSTEM, AND PROCESSING METHOD FOR A PREPAID CARD DEVICE

(75) Inventor: Chiharu Takeuchi, Azumino-shi (JP)

(73) Assignee: Seiko Epson Corporation, Tokyo (JP)

(21) Appl. No.: 13/167,005

(22) Filed: Jun. 23, 2011

(30) Foreign Application Priority Data
Jun. 23, 2010 (JP) 2010-142228

(51) Int. Cl. G06Q 20/00

(52) U.S. Cl. 705/23

(57) ABSTRACT

A processing system for managed prepaid cards can be introduced at low cost without requiring changing POS terminals. An expansion board is used connected to an activation server that activates prepaid cards, a barcode scanner, and a POS terminal. The expansion board has a product information acquisition unit that acquires product information from the barcode scanner; a product information discrimination unit that determines if the acquired product information is for a managed prepaid card that requires activation; a product information conversion unit that converts the product information to product information data that can be interpreted by the POS terminal; a product information data output unit that outputs the product information data to the POS terminal; and an activation request unit that sends the product information with an activation request to the activation request for validation.

### BACKGROUND

1. Technical Field

The present invention relates to a prepaid card processing device that is used connected to an activation server that enables prepaid cards for use and asserts a prepaid card activation request, to an prepaid card processing system, and to the processing method of the prepaid card processing device.

2. Related Art

Prepaid cards that are managed by an activation server and are charged with a certain monetary value by the activation process of the activation server (referred to herein as “managed prepaid cards”) are known from the literature. See, for example, U.S. Pat. No. 5,777,305.

While common gift certificates and prepaid cards such as conventional telephone cards are precharged for immediate use before entering market distribution channels, managed prepaid cards are activated and become “charged” or usable only at the point of sale. As a result, managed prepaid cards offer many advantages, including no risk of theft or loss and few inventory control issues. In the United States, for example, managed prepaid cards are widely used as gift certificates and sales promotion tools, and a wide range of managed prepaid cards are sold at supermarkets, drug stores, shopping centers, and other places of business.

A disadvantage of managed prepaid cards is the cost required to introduce the processing system. Because an activation request process must be executed with the activation server by the POS terminal when a managed prepaid card is sold, introducing a managed prepaid card processing system is costly because of the need to replace the POS system or change the programs run by the POS terminals or store computers. Many retailers are therefore obliged to forgo selling managed prepaid cards despite managed prepaid cards offering many advantages.

### SUMMARY

A prepaid card processing device, a prepaid card processing system, and a processing method for a prepaid card processing device according to the invention enable introducing a managed prepaid card processing system at a low cost without replacing the POS system, for example.

A first aspect of the invention is a prepaid card processing device that is used connected to an activation server that activates a prepaid card, a product information input device that inputs product information for products including the prepaid card, and a POS terminal that runs a transaction process for products including the prepaid card. The prepaid card processing device includes: a product information acquisition unit that acquires product information from the product information input device; a product information discrimination unit that determines if the acquired product information indicates a prepaid card that requires activation; a product information conversion unit that converts the product information to product information data that can be interpreted by the POS terminal when the product information indicates a prepaid card; a product information data output unit that outputs the product information data to the POS terminal; and an activation request unit that sends the product information and an activation request to the activation server when the product information indicates a prepaid card.

Another aspect of the invention is a processing method of a prepaid card processing device that is used connected to an activation server that activates a prepaid card, a product information input device that inputs product information for products including the prepaid card, and a POS terminal that runs a transaction process for products including the prepaid card. The processing method includes a product information acquisition step that acquires product information from the product information input device; a product information discrimination step that determines if the acquired product information indicates a prepaid card that requires activation; a product information conversion step that converts the product information to product information data that can be interpreted by the POS terminal when the product information indicates a prepaid card; a product information data output step that outputs the product information data to the POS terminal; and an activation request step that sends the product information and an activation request to the activation server when the product information indicates a prepaid card.

These aspects of the invention can execute an activation request process with an activation server by inserting a prepaid card processing device between the POS terminal and product information input device (such as a barcode scanner). As a result, a system for processing managed prepaid cards (prepaid cards that require activation) can be introduced at low cost without needing to replace the POS system or change the programs run by the POS terminal or store (host) computer.

In addition, because these aspects of the invention also have a conversion function that converts product information for prepaid cards to product information data that can be interpreted by the POS terminal, a function for recognizing prepaid card product information (generally 32-bit data including a 16-bit product code and a 16-bit serial number) is not required on the POS terminal side. More specifically, changing the program on the POS terminal for recognizing product information is not necessary. Practical utility can also be improved because product information from a variety of product information input devices, including barcode scanners, MICR (magnetic ink character readers), and RFID (Radio Frequency IDentification) readers, can be input.

Preferably, the prepaid card processing device according to another aspect of the invention also has an activation message acquisition unit that receives an activation message indicating approval of the activation request from the activation server, and the product information conversion unit converts the product information to the product information data after receiving the activation message.

With this aspect of the invention product information data is output to the POS terminal after activation is approved. As a result, problems that can occur when the transaction (payment) process is first completed on the POS terminal side and activation of the managed prepaid card is then not approved or purchase of the managed prepaid card is cancelled are prevented.

A prepaid card processing device according to another aspect of the invention preferably is preferably used additionally connected to a printing device that issues receipts, and also includes a receipt print data acquisition unit that receives receipt print data based on the product information data from the POS terminal, and a receipt print data output unit that outputs the acquired receipt print data to the printing device.

This aspect of the invention enables rendering the invention with the prepaid card processing device disposed between the POS terminal and product information input device and the printing device.

A prepaid card processing device according to another aspect of the invention preferably also has a receipt print data acquisition unit that receives receipt print data based on the product information data from the POS terminal; and a receipt print data discrimination unit that determines if the product information contained in the acquired receipt print data identifies a prepaid card. The activation request unit asserts an activation request when the receipt print data discrimination unit determines that the product information identifies a prepaid card.

With this aspect of the invention problems such as executing only the activation request process and not executing the transaction process are prevented because the activation request is sent to the activation server after receiving receipt print data from the POS terminal. While such problems generally do not occur when the POS terminal and prepaid card processing device are located near each other, the danger of an activated prepaid card being stolen or lost after the card is charged (that is, enabled for use) but before the payment process is completed increases when the POS terminal and prepaid card processing device are remote from each other, and this aspect of the invention can prevent such damage.

A prepaid card processing device according to another aspect of the invention preferably also has a temporary storage unit that temporarily stores the product information when the product information discrimination unit determines that the acquired product information identifies a prepaid card. The receipt print data discrimination unit determines that the product information identifies a prepaid card when the product information contained in the acquired receipt print data is stored in the temporary storage unit; and the activation request unit asserts an activation request using the product information stored in the temporary storage unit.

This aspect of the invention stores the acquired product information in a temporary storage unit, and after acquiring receipt print data compares the product information in the receipt print data with the product information stored in the temporary storage unit. As a result, inclusion of a managed prepaid card in the purchased products can be accurately determined without maintaining a card information database for evaluating managed prepaid cards.

A prepaid card processing device according to another aspect of the invention is preferably used additionally connected to a printing device that issues receipts, and also includes a receipt print data output unit that outputs the acquired receipt print data to the printing device.

This aspect of the invention enables rendering the invention with the prepaid card processing device disposed between the POS terminal and product information input device and the printing device.

A prepaid card processing device according to another aspect of the invention preferably also has an activation message acquisition unit that receives an activation message indicating approval of the activation request from the activation server; and an activation message reporting unit that reports acquisition of the activation message.

This aspect of the invention enables an employee (POS terminal operator) and customer to check completion of activation because the prepaid card processing device reports receiving an activation message.

Note that the activation message reporting unit preferably reports completion of activation by displaying a text message on a display device, turning an LED or other indicator on, or outputting an electronic sound.

Further preferably, a prepaid card processing device according to another aspect of the invention preferably also has a certificate print data generating unit that generates certificate print data for issuing an activation certificate certifying activation of the prepaid card when the activation message is received; and a certificate print data output unit that outputs the certificate print data to the printing device.

By issuing an activation certificate, this aspect of the invention can plainly certify activation of the managed prepaid card to the customer.

An activation certificate preferably includes information such as the product name, product code, serial number, activated amount (face amount), expiration date, activation date and time, and the name of the business where the card was activated.

A prepaid card processing device according to another aspect of the invention preferably also has a deactivation request unit that sends the product information and a deactivation request to the activation server when the product information acquisition unit receives product information for a prepaid card that is to be deactivated; and a deactivation message acquisition unit that receives a deactivation message indicating approval of the deactivation request from the activation server. The certificate print data generating unit generates certificate print data for issuing a deactivation certificate certifying deactivation of the prepaid card when the deactivation message is received.

When a managed prepaid card is returned, for example, this aspect of the invention enables executing a deactivation request process for the managed prepaid card. In addition, by issuing a deactivation certificate, this aspect of the invention can plainly certify deactivation of the managed prepaid card to the customer.

Another aspect of the invention is an expansion board that has the parts of the prepaid card processing device described above and is configured to be removably installed in a printing device.

By rendering the prepaid card processing device as an expansion board, this aspect of the invention does not require additional counter space for installation, for example, and thus helps save space. The expansion board can also simplify system configuration.

Another aspect of the invention is a prepaid card processing system including the prepaid card processing device described above and a printing device.

Another aspect of the invention is a program that causes a computer to execute the steps of the processing method of the prepaid card processing device described above.

These aspects of the invention enable rendering the processing method of a prepaid card processing system and a prepaid card processing device that enables introducing a system at low cost to process managed prepaid cards without needing to replace the POS system, for example.

Further preferably in a prepaid card processing system according to another aspect of the invention, the printing device prints the receipt print data and the certificate print data as a single receipt.

By issuing a sales receipt and activation certificate, or a return receipt and a deactivation certificate, as a single receipt, this aspect of the invention reduces use of receipt paper and promotes resource conservation compared with a configuration in which separate receipts are issued. This also prevents the sales clerk from failing to give a receipt to the customer, which can happen when plural receipts are issued.

Note that the receipt print data and the certificate print data can be combined on the prepaid card processing device side or the printer side.

Further preferably in a prepaid card processing system according to another aspect of the invention, the certificate print data is printed with emphasis over the receipt print data.

This aspect of the invention enables prompting the customer to check the activation certificate or deactivation certificate, which is important information. Note that “printed with emphasis” includes, for example, using bold text, color printing, underlining, printed frames, or other specific text attributes that are added to embellish and make the area where the certificate print data is printed stand out from the other receipt data.

Further preferably, in a prepaid card processing system according to another aspect of the invention the printing device includes a first printer and a second printer; the receipt print data output unit outputs the receipt print data to the first printer; and the certificate print data output unit outputs the certificate print data to the second printer.

By printing sales receipts and certificates on different printers, this aspect of the invention enables printing each appropriately. For example, sales receipts could be printed in black and white while certificates are printed in color.

Further preferably in a prepaid card processing system according to another aspect of the invention, the certificate print data output unit outputs the certificate print data to both the first printer and the second printer.

By printing certificates from both the first printer and second printer, this aspect of the invention enables using one of the certificates for gift packages.

A configuration that has a specific operating member disposed to the prepaid card processing system, and issues certificates from both the first and second printers only when this specific operating member is operated, is also conceivable.

Further alternatively, a configuration that issues activation certificates from both the first and second printers, and issues deactivation certificates only from one printer, is also conceivable.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 shows the configuration of a POS system.

FIG. 2 is a function block diagram of an expansion board according to a first embodiment of the invention.

FIG. 3A shows an example of a sales receipt, and FIG. 3B shows an example of a proof of activation certificate.

FIG. 4 shows an example of a combined receipt.

FIG. 5 is a flow chart showing a prepaid card processing method according to the first embodiment of the invention.

FIG. 6 continues the flow chart shown in FIG. 5.

FIG. 7 continues the flow chart shown in FIG. 5 and FIG. 6.

FIG. 8 shows an example of a proof of activation certificate issued as a gift.

FIG. 9 is a function block diagram of an expansion board according to a second embodiment of the invention.

FIG. 10 is a flow chart showing a prepaid card processing method according to the second embodiment of the invention.

FIG. 11 continues the flow chart shown in FIG. 10.

FIG. 12 continues the flow chart shown in FIG. 10 and FIG. 11.

FIG. 13 shows the configuration of a POS system according to another embodiment of the invention.

### DESCRIPTION OF EMBODIMENTS

### Embodiment 1

A prepaid card processing device, a prepaid card processing system, and a method of processing prepaid cards using the prepaid card processing device according to the invention are described next with reference to the accompanying figures. Note that the prepaid card processing device and other aspects of the invention are described below as they apply to a POS system SY used in a retail business.

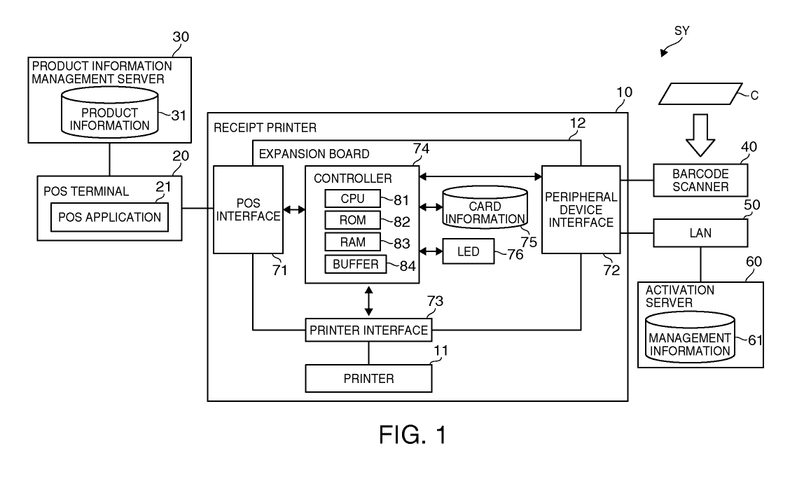

FIG. 1 shows the configuration of a POS system SY according to the first embodiment of the invention. As shown in the figure, the POS system SY includes a receipt printer 10, POS terminal 20, product information management server 30, barcode scanner 40 (product information input device), LAN 50, and activation server 60.

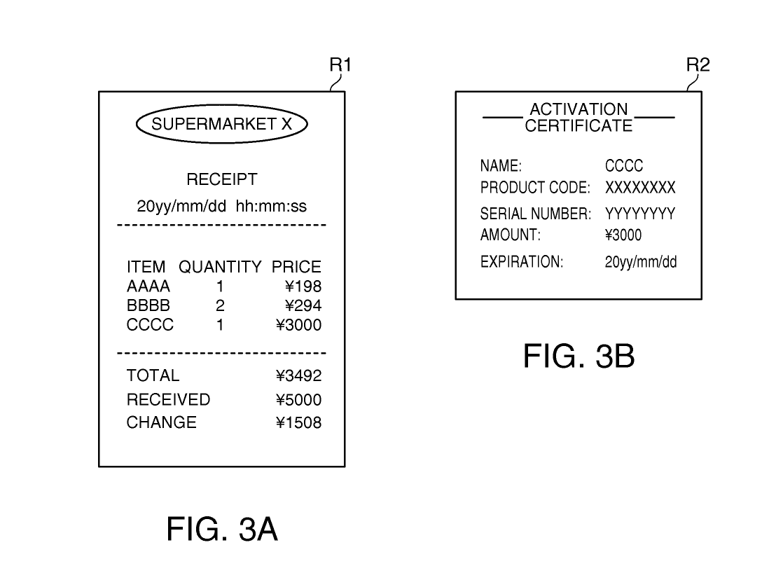

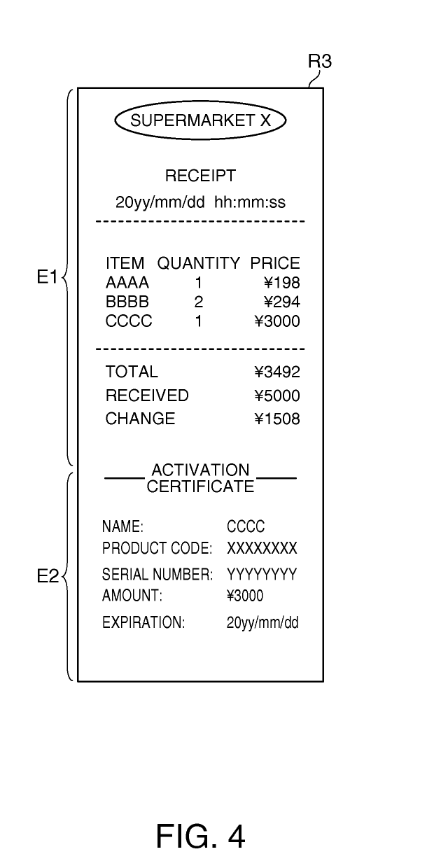

The receipt printer 10 includes a printer 11 (printing device) and an expansion board 12 connected thereto. The printer 11 includes the mechanisms needed to issue receipts R (see FIG. 3 and FIG. 4), including a print mechanism, paper transportation mechanism, paper cutting mechanism, and means of controlling these).

The expansion board 12 is an expansion interface board that functions as a prepaid card processing device.

The receipt printer 10 functions as a prepaid card processing system.

The expansion board 12 includes a POS interface 71 to which the POS terminal 20 is connected, a peripheral device interface 72 to which the barcode scanner 40 and LAN 50 are connected, and a printer interface 73 to which the printer 11 is connected. Note that while not specifically shown in the figures, the peripheral device interface 72 is a dedicated interface disposed for each individual peripheral device. The POS interface 71 may also have different interfaces for input and output.

The expansion board 12 has a controller 74, card information database 75 (prepaid card storage unit), and LED (light-emitting diode) 76.

The controller 74 includes a CPU 81 (central processing unit), ROM 82 (read-only memory) that stores control data and control programs enabling the CPU 81 to control operation, RAM 83 (random access memory) that is used as working memory by the CPU 81, and a buffer 84 used as temporary storage.

The card information database 75 stores a database of product code and product name information for managed prepaid cards C that are managed by the activation server 60 and activated by an activation process executed on the activation server 60.

The LED 76 indicates whether card activation was approved (when an activation message is received) or not approved by the activation server 60 by lighting steady or flashing appropriately.

Control programs stored in ROM 82 include, for example, a prepaid card processing program for identifying managed prepaid cards C or issuing proof of activation certificates, an input/output control program for exchanging data with the POS terminal 20, and a communication control program for communicating with the activation server 60.

The barcode scanner 40 reads the product code applied or printed on each product (including managed prepaid cards C).

The activation server 60 is connected to the receipt printer 10 (expansion board 12) through a network such as a LAN 50 or the Internet. The activation server 60 manages managed prepaid cards C that are sold through retail channels, and has a management information database 61 that stores prepaid card management information.

The management information database 61 stores information including the serial number, status (activated or inactivated), usage history, remaining balance, and expiration date of each managed prepaid card C.

When an activation request for a managed prepaid card C is received from the expansion board 12, the activation server 60 references the management information database 61 to determine if the request is valid or invalid, and returns an activation message if the request is valid. The activation request is not validated, when the serial number of the managed prepaid card C is not stored in the management information database 61, the card has already been activated, or there is a history of illegal use, for example.

When a deactivation request is received for a managed prepaid card C from the expansion board 12, the activation server 60 also references the management information database 61 to determine if the request is valid or not, and returns a deactivation message if the request is validated. A deactivation request may also be received when a managed prepaid card C is returned. A deactivation request may not be validated when the serial number of the managed prepaid card C is not found in the management information database 61, or the card has already been deactivated, for example.

The POS terminal 20 has a POS application 21 and runs a transaction process (including a payment process and a product return process). The product information management server 30 maintains a product information database 31 that stores product name, product code, and price information for each product. Product information relating to the managed prepaid cards C is also stored in the product information database 31.

When the scanned data read by the barcode scanner 40 is acquired through the expansion board 12, the POS terminal 20 references the product information database 31 and generates receipt print data for issuing a transaction receipt R1 (see FIG. 3A). The resulting receipt print data is output to the receipt printer 10 (expansion board 12).

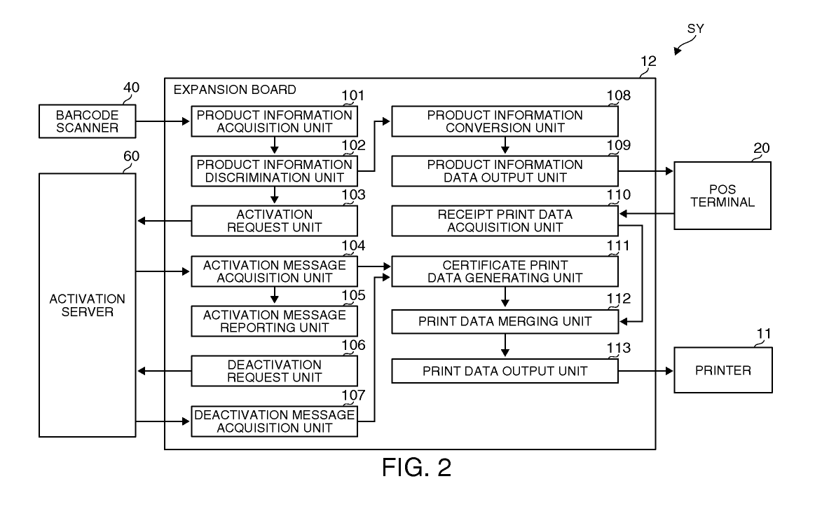

The functional configuration of the expansion board 12 is described next with reference to FIG. 2. The main functional elements of the expansion board 12 include a product information acquisition unit 101, product information discrimination unit 102, activation request unit 103, activation message acquisition unit 104, activation message reporting unit 105, deactivation request unit 106, deactivation message acquisition unit 107, product information conversion unit 108, product information data output unit 109, receipt print data acquisition unit 110, certificate print data generating unit 111, print data merging unit 112, and print data output unit 113 (receipt print data output unit, certificate print data output unit).

The product information acquisition unit 101 acquires product information from the barcode scanner 40. The product information is obtained by the barcode scanner 40 reading the product barcode. A 16-bit product code is acquired for most products. For managed prepaid cards C, 32 bits of information including a 16-bit product code and a 16-bit serial number are acquired. Note that the product information acquisition unit 101 could acquire product information from product information input devices other than a barcode scanner 40, including, for example, an MICR (Magnetic Ink Character Reader) or RFID (Radio Frequency IDentification) reader.

The product information discrimination unit 102 determines if the product information acquired by the product information acquisition unit 101 is for a managed prepaid card C. More specifically, the product information discrimination unit 102 determines that the information is for a managed prepaid card C if the product information (the product code contained in the product information) is stored in the card information database 75.

When the product information discrimination unit 102 determines that the acquired product information identifies a managed prepaid card C, the activation request unit 103 sends an activation request including the product information (product code and serial number) to the activation server 60.

The activation message acquisition unit 104 acquires an activation message indicating validation of the activation request from the activation server 60.

The activation message reporting unit 105 causes the LED 76 to light steady for several seconds when an activation message is received by the activation message acquisition unit 104. Note that when a rejection notice (activation is not approved) is received from the activation server 60, the LED 76 flashes for several seconds.

When the product information acquisition unit 101 gets product information for a managed prepaid card C that is to be deactivated, the deactivation request unit 106 sends a deactivation request including the product information (product code and serial number) to the activation server 60. Note that whether or not a card is to be deactivated is determined when the product information for a managed prepaid card C is received immediately after a product return code that is input from the barcode scanner 40 or a keyboard not shown.

The deactivation message acquisition unit 107 acquires a deactivation message indicating validation of the deactivation request from the activation server 60.

When the product information acquired by the product information acquisition unit 101 denotes a managed prepaid card C, the product information conversion unit 108 converts the product information to product information data that can be interpreted by the POS terminal 20. In this embodiment of the invention the POS terminal 20 is compatible only with input of the 16-bit product code. As a result, when product information including both a 16-bit product code and a 16-bit serial number for a managed prepaid card C is acquired, only the 16-bit product code is converted to the product information data. When product information is received from a product information input device other than the barcode scanner 40, that product information is likewise converted to the product information data (a 16-bit product code).

Note that in this embodiment of the invention the product information conversion unit 108 converts the product information after an activation message or a deactivation message is acquired.

The product information data output unit 109 outputs the product information data, which is the data resulting from conversion by the product information conversion unit 108, to the POS terminal 20.

The receipt print data acquisition unit 110 acquires receipt print data that is generated from the product information data from the POS terminal 20.

When the activation message is acquired, the certificate print data generating unit 111 generates activation certificate print data for issuing an activation certificate certifying that the managed prepaid card C was activated. When a deactivation message is received, the certificate print data generating unit 111 generates deactivation certificate print data for issuing a deactivation certificate certifying that the managed prepaid card C was deactivated.

The print data merging unit 112 combines the receipt print data acquired by the receipt print data acquisition unit 110 and the certificate print data generated by the certificate print data generating unit 111.

If an activation message was received, receipt print data for a transaction receipt R1 (referred to below as sales receipt R1) describing the sales result at the time of purchase, and certificate print data for an activation certificate R2, are combined.

If a deactivation message was received, receipt print data for a transaction receipt (a “return receipt” below) indicating the result of the product return, and certificate print data for a deactivation certificate (not shown), are combined.

When product including a managed prepaid card C is purchased, the print data output unit 113 outputs merged print data combining the receipt print data for a sales receipt R1 and certificate print data for an activation certificate R2 to the printer 11. When product including a managed prepaid card C is returned, the print data output unit 113 outputs merged print data including the receipt print data for a return receipt and certificate print data for a deactivation certificate to the printer 11.

If a managed prepaid card C is not included in the purchased product or returned product, only receipt print data is output to the printer 11.

The printer 11 receives the combined print data or receipt print data, and issues the appropriate type of receipt R.

Different types of receipts R are described next with reference to FIG. 3 and FIG. 4. FIG. 3A shows an example of a sales receipt R1. As shown in the figure, the sales receipt R1 includes information that it is a receipt, the transaction date, and the transaction content. Note that while a return receipt is not specifically shown, indication that it is a return receipt instead of a sales receipt is printed.

FIG. 3B shows an example of an activation certificate R2. As shown in the figure, an activation certificate R2 includes indication that it is an activation certificate, and the product name, product code, serial number, activated amount (face amount), and expiration date of the managed prepaid card C. The content of these items can be determined from the product information acquired from the barcode scanner 40, or from the activation message acquired from the activation server 60.

Note that while a deactivation certificate is not specifically shown, a deactivation certificate includes identification as being a deactivation certificate instead of an activation certificate.

FIG. 4 shows an example of a combined receipt R3 printed using the merged print data combining receipt print data for a sales receipt R1 and certificate print data for an activation certificate R2.

In this embodiment of the invention the receipt print data is acquired after certificate print data is generated for an activation certificate R2. As a result, the certificate print data is temporarily stored in the buffer 84, and the certificate print data (indicated by E2 in FIG. 4) is added following the receipt print data (E1 in the figure) after the receipt print data is acquired to issue a combined receipt R3. Note that while not shown in the figures, a return receipt and deactivation certificate are similarly printed as a combined receipt.

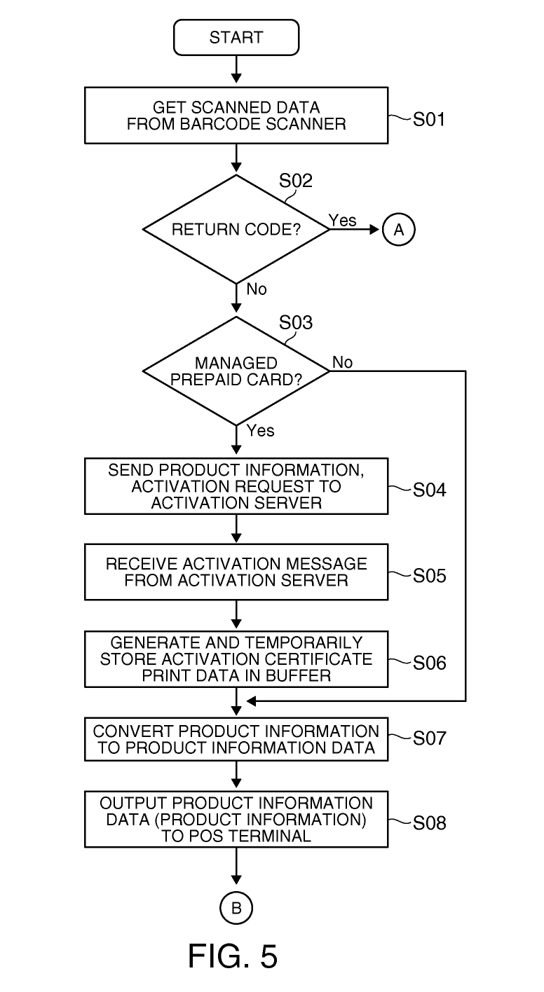

A prepaid card process executed primarily by the expansion board 12 is described next with reference to FIG. 5 to FIG. 7. The activation server 60 validates all activation requests and deactivation requests from the expansion board 12 in the example described below.

When the expansion board 12 (controller 74) acquires scanned data from the barcode scanner 40 (the result of the barcode scanner 40 reading the product code) (S01), it determines if a return code was received (S02). If a return code was not received (S02 returns No), the controller 74 determines if data (product information) for a managed prepaid card C was received (S03). More specifically, the controller 74 determines if a product code contained in the scan data is stored in the card information database 75.

If in S03 data for a managed prepaid card C is detected (S03 returns Yes), the controller 74 sends the product information and an activation request to the activation server 60 (S04). When an activation message is received from the activation server 60 (S05), the controller 74 generates and stores activation certificate print data in the buffer 84 (S06). Note that while not shown in the figure, the LED 76 also turns on at this time.

After generating the activation certificate print data, the controller 74 converts the product information acquired in S01 to product information data that can be used by the POS terminal 20 (S07), and outputs the product information data to the POS terminal 20 (S08).

If the acquired product information is determined to not be for a managed prepaid card C (S03 returns No), the product information is converted to product information data (S07 when product information is acquired from a product information input device other than the barcode scanner 40), and the converted product data or the product information itself (when a 16-bit product code is acquired from the barcode scanner 40) is output to the POS terminal 20 (S08).

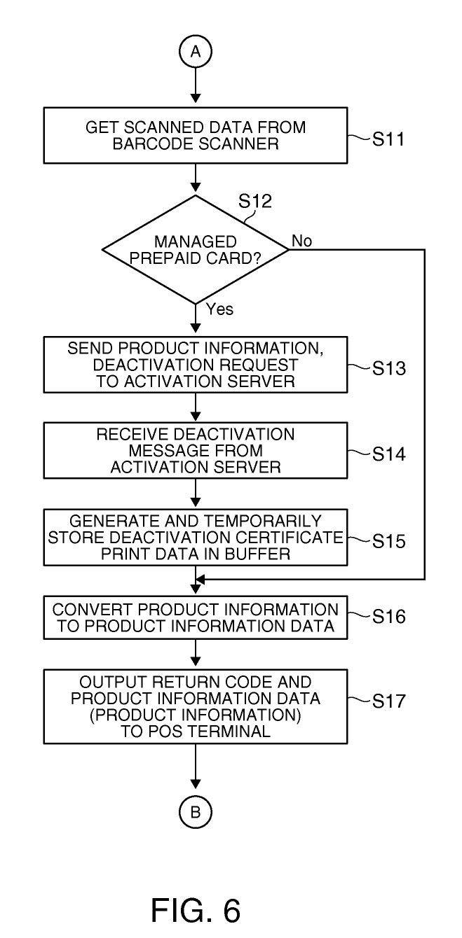

If the scan data acquired in S02 is a return code (S02 returns Yes), the controller 74 acquires the product information from the barcode scanner 40 (S11) and determines if the product information is for a managed prepaid card C (S12) as shown in FIG. 6.

If the product information is for a managed prepaid card C (S12 returns Yes), the controller 74 sends the product information and a deactivation request to the activation server 60 (S13).

When a deactivation message is then received from the activation server 60 (S14), the controller 74 generates and stores deactivation certificate print data in the buffer 84 (S15).

After generating the deactivation certificate print data, the controller 74 converts the product information acquired in S11 to product information data that can be received by the POS terminal 20 (S16), and outputs the product information data and return code to the POS terminal 20 (S17). The POS terminal 20 then generates receipt print data for printing a return receipt based on the return code and product information data.

If the acquired product information is not for a managed prepaid card C (S12 returns No), the controller 74 converts the product information to product information data as necessary (S16), and outputs the converted product data or product information itself with the return code to the POS terminal 20 (S17).

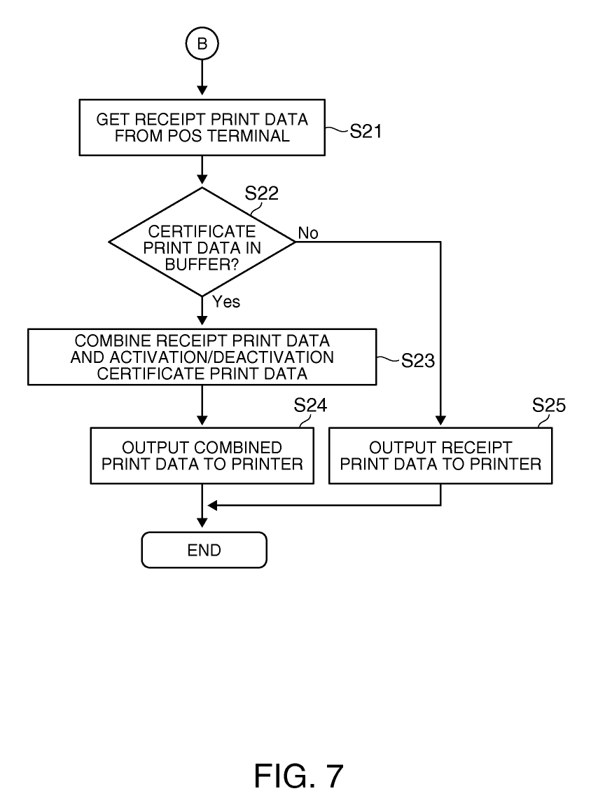

When receipt print data is received from the POS terminal 20 after step S08 or S17 as shown in FIG. 7 (S21), the controller 74 determines if certificate print data is stored in the buffer 84 (S22). If it is (S22 returns Yes), the controller 74 combines the acquired receipt print data with the certificate print data read from the buffer 84 (S23), and outputs the merged print data to the printer 11 (S24). If certificate print data is not stored in the buffer 84 (S22 returns No), the controller 74 outputs only the receipt print data acquired in S21 to the printer 11 (S25).

With a POS system SY according to this embodiment of the invention, an activation request process can be executed with the activation server 60 by installing the expansion board 12 in the receipt printer 10. As a result, a system for processing managed prepaid cards C can be introduced at a low cost without needing to change the POS terminal 20 or POS application 21, or changing the firmware of the printer 11.

In addition, because the prepaid card process can be executed by the expansion board 12, counter space for installing a prepaid card processing device is not needed and available space can be used efficiently. Furthermore, because the expansion board 12 has a conversion function for converting product information for a managed prepaid card C to product information data that can be interpreted by the POS terminal 20, the expansion board 12 can also be used with a POS terminal 20 that cannot process data in 32-bit blocks. Furthermore, this conversion function enables inputting product information from product information input devices other than barcode scanners 40, thereby improving general utility.

In addition, because the POS system SY according to this embodiment of the invention outputs the product information data to the POS terminal 20 after activation is confirmed, there are none of the problems that occur when the POS terminal 20 runs the transaction process first and the validity of the managed prepaid card C is not confirmed or the customer then decides not to buy the managed prepaid card C. In addition, because an activation certificate R2 or deactivation certificate is issued when an activation message or deactivation message is received, activation or deactivation of the managed prepaid card C can be clearly certified for the customer.

This embodiment of the invention merges the receipt print data and certificate print data, and issues a single combined receipt, but the transaction (sales) receipt and activation/deactivation certificate could be issued separately. In this case certificate print data does not need to be temporarily stored in the buffer 84.

Furthermore, whether printed as a combined receipt or separately, the certificate print data may be printed with emphasis to clearly differentiate it from the receipt print data. This configuration can promote confirmation of the activation/deactivation certificate, which is important information, by the customer. Note that “printed with emphasis” as used here includes, for example, using bold text, color printing, underlining, printed frames, or other specific character attributes that are added to make the area where the certificate print data is printed stand out from the other receipt data.

Furthermore, when the transaction receipt and activation/deactivation certificate are printed separately, one of them may be printed on one printer 11 (a first printer) and the other printed on another printer (a second printer). In this case the other printer is connected to the peripheral device interface 72.

In addition, the print data output unit 113 is separated into a receipt print data output unit and a certificate print data output unit, the former outputting receipt print data to the printer 11 and the latter outputting certificate print data to the other printer.

Because this aspect of the invention prints transaction receipts and certificates on separate printers, both can be printed appropriately. For example, sales receipts could be printed in black and white, and activation/deactivation certificates could be printed in color, or sales receipts could be printed on thermal paper while activation/deactivation certificates are printed with an inkjet printer.

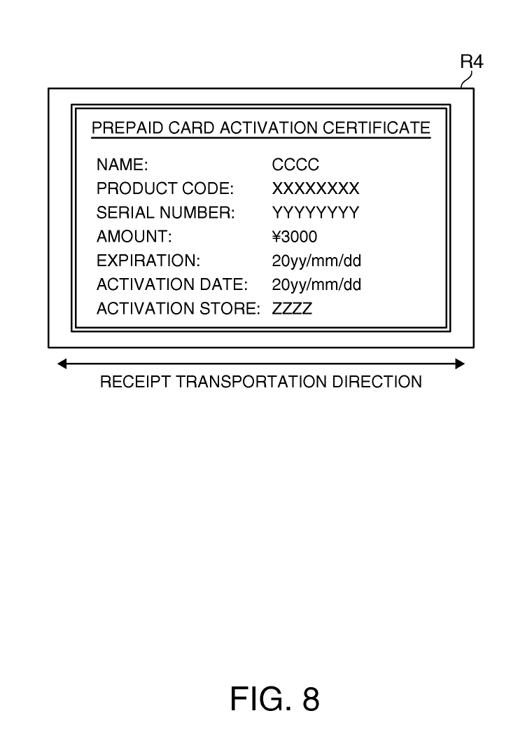

When an additional printer is connected, the certificate print data output unit may output the certificate print data to both printer 11 and the other printer. In this case the combined receipt R3 shown in FIG. 4 may be issued from the printer 11, and an activation certificate R4 for a gift such as shown in FIG. 8 may be issued from the other printer. Note that a gift activation certificate R4 is preferably printed with a different design, format, or content than the activation certificate R2 (see FIG. 3B) output from the printer 11. Compared with the activation certificate R2 shown in FIG. 3B, the orientation relative to the paper feed direction is changed so that the direction of receipt conveyance matches the direction in which the text is printed, and decorative information such as a border and underlining are added, as shown in FIG. 8. The printed content also differs by the addition of an activation date and the business where the card was activated.

Because managed prepaid cards C are commonly purchased as gifts, separately issuing gift activation certificates R4 can improve customer satisfaction for customers that purchase a managed prepaid card C as a gift certificate.

Further alternatively, a specific operating member could be disposed to the expansion board 12 so that an activation/deactivation certificate is issued from the printer 11 and other printer only when the operating member is operated.

Further alternatively, a configuration in which activation certificates are output from both the printer 11 and other printer, and deactivation certificates are output from only one of the printers, is also conceivable.

The activation message reporting unit 105 in the foregoing embodiment reports completion of activation by turning on an LED 76, but completion of activation may alternatively be reported by, for example, displaying text on a display device (such as a customer display connected to the peripheral device interface 72 and printer 11), or sounding an electronic buzzer. Completion of deactivation may be similarly reported.

The product information discrimination unit 102 in the foregoing embodiment references the card information database 75 and determines if the acquired product information denotes a managed prepaid card C, but managed prepaid cards C may alternatively be detected from the format of the product information. For example, the product information discrimination unit 102 could identify a managed prepaid card C when the product information is 32 bits long, or identify a managed prepaid card C when specific information is contained in the product information. The card information database 75 can be omitted from a configuration that uses the format of the product information to identify managed prepaid cards C.

### Embodiment 2

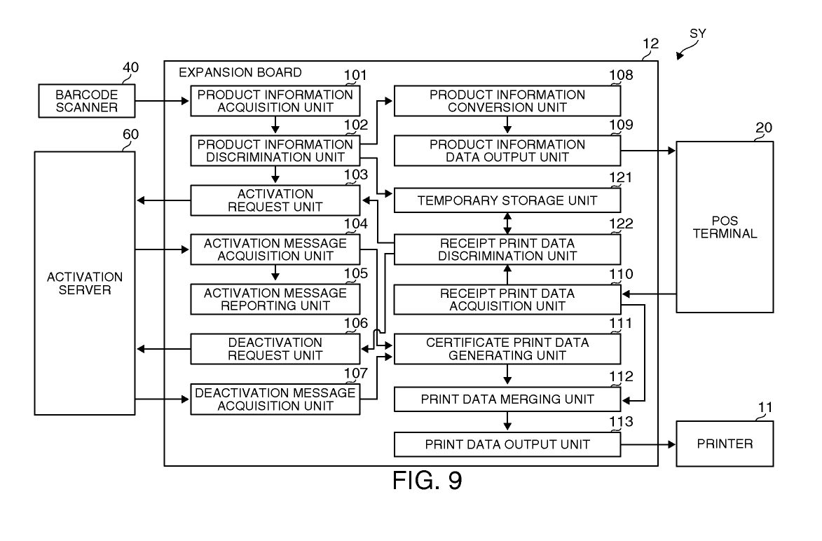

A second embodiment of the invention is described next with reference to FIG. 9 to FIG. 12.

The embodiment described above sends an activation/deactivation request to the activation server 60, receives an activation or deactivation message, and then outputs the product information data to the POS terminal 20 and receives receipt print data. This embodiment differs by sending the activation/deactivation request to the activation server 60 after acquiring receipt print data from the POS terminal 20. Only this difference from the first embodiment is described below.

Note that like parts in this and the first embodiment are identified by like reference numerals and further description thereof is omitted. In addition, variations that can be applied to the first embodiment can also be applied to the same parts in this embodiment of the invention.

FIG. 9 is a function block diagram of a expansion board 12 according to the second embodiment of the invention. The expansion board 12 according to this embodiment of the invention differs from that in the first embodiment by the addition of a temporary storage unit 121 and a receipt print data discrimination unit 122.

When the product information discrimination unit 102 determines that the acquired product information is for a managed prepaid card C, the temporary storage unit 121 temporarily stores the product information and is rendered mainly by RAM 83 (FIG. 1). The stored product information includes the product code and serial number contained in the acquired product information, and the product name corresponding to the product code read from the card information database 75 (prepaid card storage unit).

As described in further detail below, the temporary storage unit 121 includes an activation storage unit that is used when executing activation requests, and a deactivation storage unit that is used when executing deactivation requests. This activation storage unit and deactivation storage unit are differentiated by the address ranges in RAM 83. Note that in this embodiment of the invention product codes are not included in the receipt print data acquired from the POS terminal 20 but product names are included.

The receipt print data discrimination unit 122 determines if the product information (product name) contained in the receipt print data acquired by the receipt print data acquisition unit 110 identifies a managed prepaid card C. More specifically, if the product name contained in the acquired receipt print data is stored in the temporary storage unit 121, the product information contained in the receipt print data is determined to be for a managed prepaid card C.

The activation request unit 103 in this embodiment of the invention asserts an activation request when the receipt print data discrimination unit 122 determines that the product information contained in the receipt print data (sales receipt) identifies a managed prepaid card C, that is, the product information is stored in the temporary storage unit 121 (activation storage unit).

Similarly, the deactivation request unit 106 in this embodiment of the invention asserts a deactivation request when the receipt print data discrimination unit 122 determines that the product information contained in the receipt print data (return receipt) identifies a managed prepaid card C, that is, that the product information is stored in the temporary storage unit 121 (deactivation storage unit).

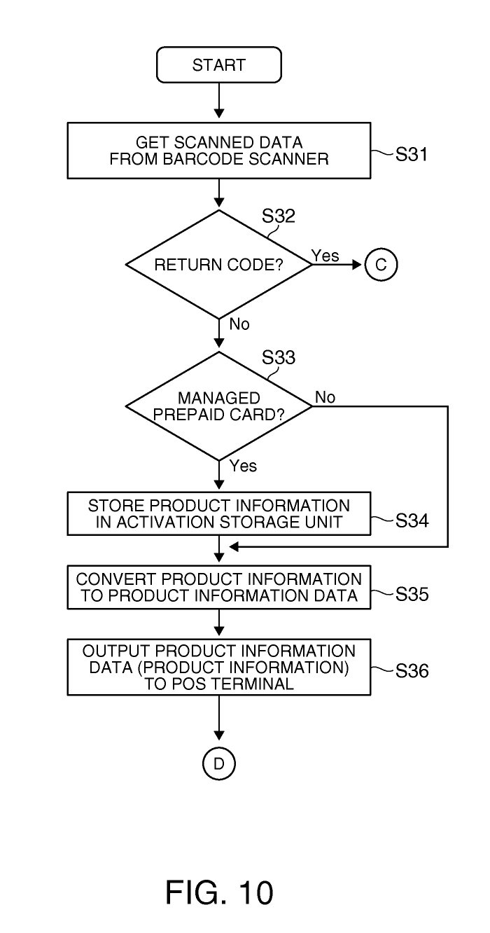

The prepaid card process executed in this second embodiment of the invention is described next with reference to the flow chart in FIG. 10 to FIG. 12.

When the expansion board 12 (controller 74) acquires scanned data from the barcode scanner 40 (S31), it determines if a return code was received (S32). If a return code was not received (S32 returns No), the controller 74 determines if data (product information) for a managed prepaid card C was received (S33) by referencing the card information database 75.

If in S33 data for a managed prepaid card C is detected (S33 returns Yes), the product information (the product code and serial number contained in the acquired product information, and the corresponding product name) is stored in the activation storage unit (temporary storage unit 121) (S34). The product information acquired in S31 is then converted to product information data that can be received by the POS terminal 20 (S35) and the product information data is output to the POS terminal 20 (S36). If the acquired product information is determined to not be for a managed prepaid card C (S33 returns No), step S34 is skipped.

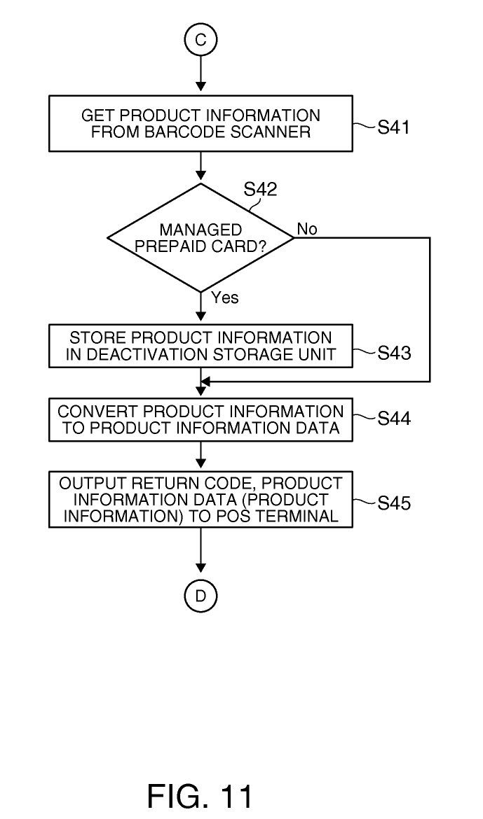

If S32 determines that the acquired scan data identifies a return code (S32 returns Yes), the product information from the barcode scanner 40 is acquired (S41) as shown in FIG. 11, and whether the product information is for a managed prepaid card C is determined (S42).

If the product information is for a managed prepaid card C (S42 returns Yes), the product information is stored in the deactivation storage unit (temporary storage unit 121) (S43). Next, the product information acquired in S41 is converted to product information data that can be received by the POS terminal 20 (S44), and the product information data is output with the return code to the POS terminal (S45).

If the acquired product information is determined to not be for a managed prepaid card C (S42 returns No), step S43 is skipped.

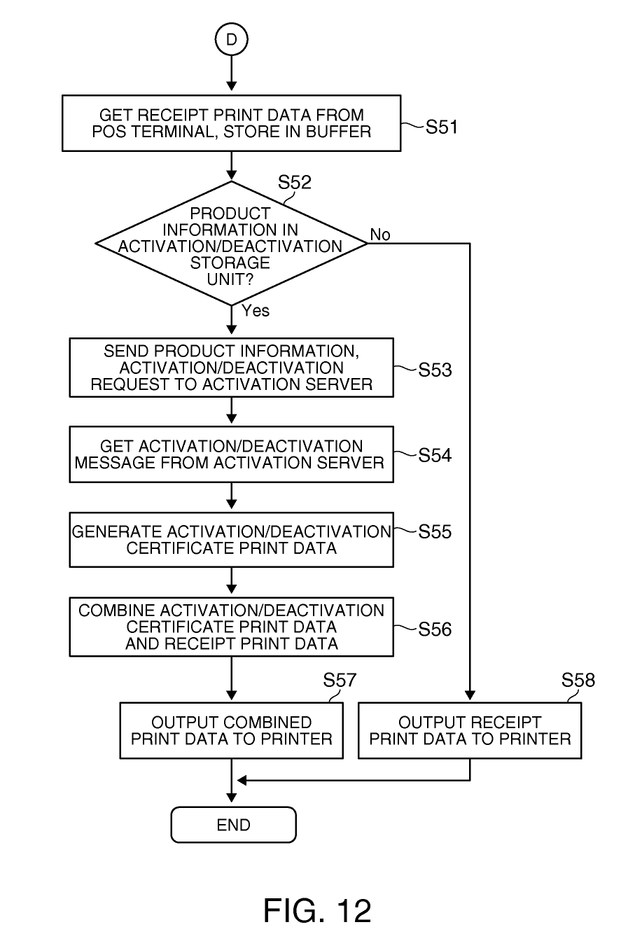

Continuing as shown in FIG. 12, receipt print data acquired from the POS terminal 20 after S36 or S45 is temporarily stored in the buffer (S51).

Whether the product information is stored in the temporary storage unit 121 is then determined (S52). If the data is stored, an activation or deactivation request is sent to the activation server 60 (S53). More specifically, an activation request is asserted when the product information is stored in the activation storage unit, and a deactivation request is asserted when the product information is stored in the deactivation storage unit.

When the activation or deactivation message is then acquired from the activation server 60 (S54), activation or deactivation certificate print data is generated based on the product information (S55), the activation or deactivation certificate print data and the receipt print data read from the buffer 84 are combined (S56), and the combined print data is output to the printer 11 (S57).

If it is determined in S52 that the product information is not stored in the temporary storage unit 121 (S52 returns No), only the receipt print data read from the buffer 84 is output to the printer (S58).

While not specifically shown in the flow chart, the transaction process in progress is cancelled in this embodiment of the invention when an activation or deactivation request is rejected by the activation server 60. For example, when a cancel code with the POS terminal 20 is defined, the cancel code is output to the POS terminal 20 triggered by receiving this rejection (non-validation) notice, and the immediately preceding transaction process is cancelled. Receipt of a rejection notice may also be reported to the operator by causing the LED 76 to flash, for example, prompting the operator to cancel the transaction process.

Because the POS system SY according to the second embodiment of the invention described above sends an activation request to the activation server 60 after receiving receipt print data from the POS terminal 20, problems such as executing only the activation request process and not executing the transaction process are prevented. As a result, problems such as an activated managed prepaid card C being stolen or lost after the card is charged but before the payment process is completed can be prevented when, for example, the POS terminal 20 and the receipt printer 10 are located in different places.

In addition, because the product name read from the card information database 75 is temporarily stored in the temporary storage unit 121 and can be compared with the product name contained in the receipt print data when product information for a managed prepaid card C is acquired, inclusion of a managed prepaid card C in the purchased products can be known even when the product code is not included in the receipt print data.

In a variation of the second embodiment, the receipt print data discrimination unit 122 determines if the product name contained in the receipt print data is stored in the card information database 75 instead of the temporary storage unit 121, and if it is stored determines if the product information identifies a managed prepaid card C.

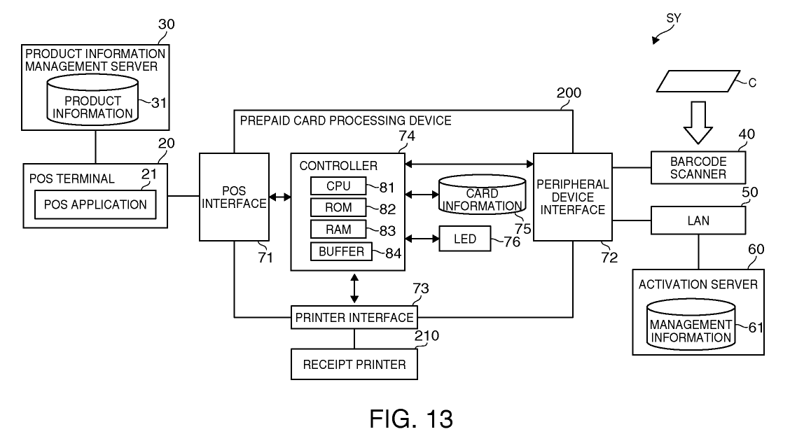

The invention is described above with reference to first and second preferred embodiments, but the invention is not so limited and the configuration of and process steps executed by the POS system SY can be changed in many ways without departing from the scope of the accompanying claims. For example, the prepaid card processing device according to the invention is rendered as an expansion board 12 installed in the receipt printer 10 in the foregoing embodiments, but may be rendered as a separate device as shown in FIG. 13. In this configuration the prepaid card processing device 200 is connected to the POS terminal 20, barcode scanner 40 LAN 50, and receipt printer 210 as a control box. This receipt printer 210 may also function as the printer 11 of the first embodiment.

The prepaid card process of the first embodiment and the prepaid card process of the second may also be combined. For example, activation requests may be handled by a configuration that sends activation requests to the activation server 60 after receipt print data is received from the POS terminal 20, and deactivation requests may be handled by a configuration that outputs product information data to the POS terminal 20 and acquires the receipt print data after sending the deactivation request to the activation server 60 and receiving a deactivation message.

The processes executed by the POS system SY (expansion board 12) in the foregoing embodiments can also be provided as a computer-executable program. The program can also be stored and distributed on a recording medium such as CD-ROM or flash memory, for example. More specifically, a program that causes a computer to function as the elements of the POS system SY (expansion board 12) described above, and a recording medium recording this program, are also included in the scope of the accompanying claims.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A prepaid card processing device that is used connected to an activation server that activates a prepaid card, a product information input device that inputs product information for products including the prepaid card, and a POS terminal that runs a transaction process for products including the prepaid card, the prepaid card processing device comprising:
a product information acquisition unit that acquires product information from the product information input device;
a product information discrimination unit that determines if the acquired product information indicates a prepaid card that requires activation;
a product information conversion unit that converts the product information to product information data that can be interpreted by the POS terminal when the product information indicates a prepaid card;
a product information data output unit that outputs the product information data to the POS terminal; and
an activation request unit that sends the product information and an activation request to the activation server when the product information indicates a prepaid card.

2. The prepaid card processing device described in claim 1, further comprising:
an activation message acquisition unit that receives an activation message indicating approval of the activation request from the activation server;
wherein the product information conversion unit converts the product information to the product information data after receiving the activation message.

3. The prepaid card processing device described in claim 2, wherein:
the prepaid card processing device is used additionally connected to a printing device that issues receipts, and also includes
a receipt print data acquisition unit that receives receipt print data based on the product information data from the POS terminal, and
a receipt print data output unit that outputs the acquired receipt print data to the printing device.

4. The prepaid card processing device described in claim 1, further comprising:
a receipt print data acquisition unit that receives receipt print data based on the product information data from the POS terminal; and
a receipt print data discrimination unit that determines if the product information contained in the acquired receipt print data identifies a prepaid card;
wherein the activation request unit asserts an activation request when the receipt print data discrimination unit determines that the product information identifies a prepaid card.

5. The prepaid card processing device described in claim 4, further comprising:
a temporary storage unit that temporarily stores the product information when the product information discrimination unit determines that the acquired product information identifies a prepaid card;
wherein the receipt print data discrimination unit determines that the product information identifies a prepaid card when the product information contained in the acquired receipt print data is stored in the temporary storage unit; and
the activation request unit asserts an activation request using the product information stored in the temporary storage unit.

6. The prepaid card processing device described in claim 5, wherein:
the prepaid card processing device is used additionally connected to a printing device that issues receipts, and also includes
a receipt print data output unit that outputs the acquired receipt print data to the printing device.

7. The prepaid card processing device described in claim 6, further comprising:
an activation message acquisition unit that receives an activation message indicating approval of the activation request from the activation server; and
an activation message reporting unit that reports acquisition of the activation message.

8. The prepaid card processing device described in claim 3, further comprising:
a certificate print data generating unit that generates certificate print data for issuing an activation certificate certifying activation of the prepaid card when the activation message is received; and
a certificate print data output unit that outputs the certificate print data to the printing device.

9. The prepaid card processing device described in claim 8, further comprising:
a deactivation request unit that sends the product information and a deactivation request to the activation server when the product information acquisition unit receives product information for a prepaid card that is to be deactivated; and
a deactivation message acquisition unit that receives a deactivation message indicating approval of the deactivation request from the activation server;
wherein the certificate print data generating unit generates certificate print data for issuing a deactivation certificate certifying deactivation of the prepaid card when the deactivation message is received.

10. A prepaid card processing system comprising:
the prepaid card processing device described in claim 8; and
a printing device.

11. The prepaid card processing system described in claim 10, wherein:
the printing device prints the receipt print data and the certificate print data as a single receipt.

12. The prepaid card processing system described in claim 11, wherein:
the certificate print data is printed with emphasis over the receipt print data.

13. The prepaid card processing system described in claim 10, wherein:
the printing device includes a first printer and a second printer;
the receipt print data output unit outputs the receipt print data to the first printer; and
the certificate print data output unit outputs the certificate print data to the second printer.

14. The prepaid card processing system described in claim 13, wherein:
the certificate print data output unit outputs the certificate print data to both the first printer and the second printer.

15. A processing method of a prepaid card processing device that is used connected to an activation server that activates a prepaid card, a product information input device that inputs product information for products including the prepaid card, and a POS terminal that runs a transaction process for products including the prepaid card, the processing method comprising:
a product information acquisition step that acquires product information from the product information input device;
a product information discrimination step that determines if the acquired product information indicates a prepaid card that requires activation;
a product information conversion step that converts the product information to product information data that can be interpreted by the POS terminal when the product information indicates a prepaid card;
a product information data output step that outputs the product information data to the POS terminal; and
an activation request step that sends the product information and an activation request to the activation server when the product information indicates a prepaid card.

16. The processing method of a prepaid card processing device described in claim 15, further comprising:
an activation message acquisition step that receives an activation message indicating approval of the activation request from the activation server;
wherein the product information conversion step converts the product information to the product information data after receiving the activation message.

17. The processing method of a prepaid card processing device described in claim 16, wherein:
a printing device that issues receipts is also connected, and the processing method also includes
a receipt print data acquisition step that receives receipt print data based on the product information data from the POS terminal, and
a receipt print data output step that outputs the acquired receipt print data to the printing device.

18. The processing method of a prepaid card processing device described in claim 15, further comprising:
a receipt print data acquisition step that receives receipt print data based on the product information data from the POS terminal; and
a receipt print data discrimination step that determines if the product information contained in the acquired receipt print data identifies a prepaid card;
wherein the activation request step asserts an activation request when the receipt print data discrimination step determines that the product information identifies a prepaid card.

19. The processing method of a prepaid card processing device described in claim 18, further comprising:
a temporary storage unit that temporarily stores the product information when the product information discrimination step determines that the acquired product information identifies a prepaid card;
wherein the receipt print data discrimination step determines that the product information identifies a prepaid card when the product information contained in the acquired receipt print data is stored in the temporary storage unit; and
the activation request step asserts an activation request using the product information stored in the temporary storage unit.

20. The processing method of a prepaid card processing device described in claim 19, wherein:
a printing device that issues receipts is also connected, and
the processing method also includes a receipt print data output step that outputs the acquired receipt print data to the printing device.
